(19) United States
(12) Patent Application Publication
(10) Pub. No.: US 2016/0371774 A1
(43) Pub. Date: Dec. 22, 2016

(54) System, Tool and Method for Distributed Risk Analysis

(71) Applicant: TRADING TECHNOLOGIES INTERNATIONAL INC., CHICAGO, IL (US)

(72) Inventor: Gerald J. O'CONNOR, Wilmette, IL (US)

(21) Appl. No.: 14/744,999

(22) Filed: Jun. 19, 2015

(51) Int. Cl. G06Q 40/04

(52) U.S. Cl. CPC G06Q 40/04

(57) ABSTRACT

A risk metric may be generated for use in calculating a risk level associated with a user trading at an exchange. The risk metric may indicate a price level at which the market may be trading a tradeable object at the exchange. The risk metric may be communicated to computing devices to enable the computing devices to calculate the risk level associated with a user without having independent access to the real-time market data at an exchange. The risk metric may be calculated by averaging different price values in the market data to indicate a relative price at which the tradeable object may be trading at the exchange. The risk metric may be calculated as a market value that may be used by multiple users or as a user-specific value. The risk metric may be continuously updated and communicated to computing devices.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

The trading devices may receive real-time information about the market in exchange for a fee. Some users of the trading devices, such as risk analysts or risk administrators, are not using the market information to execute trades at the exchange, but are instead merely using relatively small portions of the market information to calculate a level of risk associated with users that are trading on the exchange. For example, the risk analysts or risk administrators may use the market data to calculate a trader's relative position (e.g., profit or loss) in a market.

As some users of the trading devices are not using the market information in the same way as the users that are executing trades at the exchange, the fees being charged by the exchange may be relatively high for some users. Additionally, the market data that is provided from a current exchange may cause users that are calculating levels of risk to perform unnecessary calculations to determine other users' relative positions in the market.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of an example system that may be used to provide a risk metric related to one or more tradeable objects at an electronic exchange.

FIGS. 5A-5B illustrate an example display that identifies market data that may be used to generate a risk metric.

FIG. 6 is a flow diagram of an example method for determining a risk metric based on market data.

FIG. 7 is a flow diagram of an example method for determining a risk metric according to a minimum quantity value.

FIG. 8 is a flow diagram of another example method for determining a risk metric according to a minimum quantity value.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

Systems, methods, and apparatus are described for determining a custom risk metric based on and/or derived from real-time market data generated by an electronic exchange. The risk metric may be a derived value based on actual price values in the market data. For example, the risk metric may indicate a range of price levels between which the market may be trading a tradeable object at the exchange. The risk metric may be calculated by averaging price values from multiple price levels and/or over a defined period of time. In certain embodiments, the price values may include a best bid price, a best offer price, a last traded price, or a combination thereof. In certain embodiments, the risk metric may be calculated by weighting the average price values according to the quantity values corresponding to each price value.

The risk metric may be communicated or broadcast to one or more computing devices and utilized to calculate a level of risk associated with individual users and/or groups of users trading at the electronic exchange. The risk metric may enable the computing devices to measure a user's relative position (e.g., profit or loss) in the market without the need for independent access to the real-time market data generated at the electronic exchange.

In certain embodiments, the risk metric may be calculated as a market value that may be used by multiple users or as a user-specific value based on a user's position in the market. For example, the risk metric may be based on user-specific data that indicates the user's position in the market and may indicate a relative price value for the user to exit an exchange.

In certain embodiments, the risk metric may be updated based on a user request or a market event. The market event may be to an expiration of a timer, the receipt of updated market data, a change in the value of the risk metric, a change in the value of the last traded price, a change in the value of the best bid price, a change in the value of the best offer price, or a combination thereof.

In certain embodiments, the risk metric may be generated and/or communicated via a risk analysis manager, which may reside at one or more trading devices. The risk analysis manager may be implemented as a software module and/or a hardware module at the trading devices.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. BRIEF DESCRIPTION OF CERTAIN EMBODIMENTS

Systems, tools, and methods are described for determining a risk metric based on market data from an electronic exchange.

In certain embodiments, the market data includes a best bid price, a best bid quantity, a best offer price, and a best offer quantity. The market data may include a last traded price and a last traded quantity. In certain embodiments, the risk metric may be determined by calculating a weighted average of the best bid price and the best offer price using the best bid quantity and the best offer quantity. In certain embodiments, the risk metric may be determined by calculating a weighted average of the best bid price, the best offer price, and the last traded price using the best bid quantity, the best offer quantity, and the last traded quantity. In certain embodiments, the weighted average may be calculated without the last traded price or the last traded quantity when a last trade occurred before a predetermined period of time or if the best bid and best offer move outside of the last traded price.

In certain embodiments, the weighted average may be calculated based on a best bid value, a best offer value, and a last traded value. In certain embodiments, the best bid value may be calculated by multiplying the best bid quantity and the best bid price. In certain embodiments, the best offer value may be calculated by multiplying the best offer quantity and the best offer price, calculating a last traded value by multiplying the last traded quantity and the last traded price, and dividing a sum of the best bid value, the best offer value, and the last traded value by a sum of the best bid quantity, the best offer quantity, and the last traded quantity.

In certain embodiments, the risk metric may indicate an average value over a plurality of best bid prices or a plurality of best offer prices. In certain embodiments, the risk metric may indicate the average value to exit an exchange. For example, a minimum quantity to exit the position may be determined and the plurality of best bid prices or best offer prices having corresponding quantities needed to exit the position based on the best bid quantity or the best offer quantity available at each corresponding price. In certain embodiments, the risk metric may be determined by averaging the plurality of best bid prices or best offer prices that may be used to exit the position. In certain embodiments, the minimum quantity to exit the position may be a multiple of a quantity of the tradeable object associated with a user at the exchange.

In certain embodiments, the determined risk metric may be communicated to at least one computing device. For example, the risk metric may be communicated by broadcasting the risk metric to at least one computing device or sending the risk metric directly to a computing device via a message that includes a unique identifier of the computing device. The risk metric may be communicated without the market data.

In certain embodiments, the risk metric may be updated in response to a user request or a market event. For example, a market event may correspond to an expiration of a timer, a movement of the risk metric beyond a risk range, or a movement of the risk metric above or below a threshold. In certain embodiments, the risk metric may represent a risk range defined with respect to a calculated risk value. The risk metric may be updated when the calculated risk value is determined to be within an upper limit range or a lower limit range of the risk range.

The risk metric may be generated and/or communicated via a risk analysis manager, which may reside at one or more trading devices. The risk analysis manager may be executed, from memory, by a processor located at a trading device.

### II. EXAMPLE ELECTRONIC TRADING SYSTEM

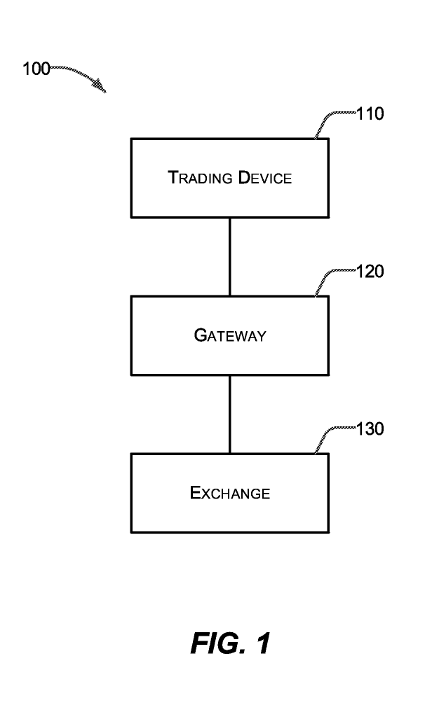

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. EXPANDED EXAMPLE ELECTRONIC TRADING SYSTEM

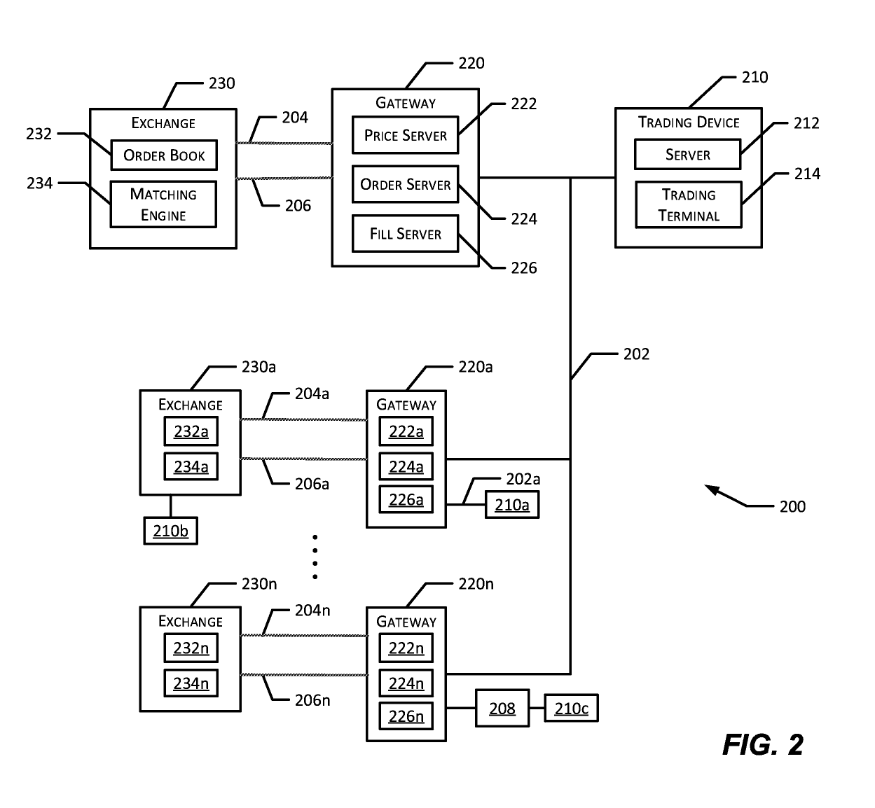

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each include instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. EXAMPLE COMPUTING DEVICE

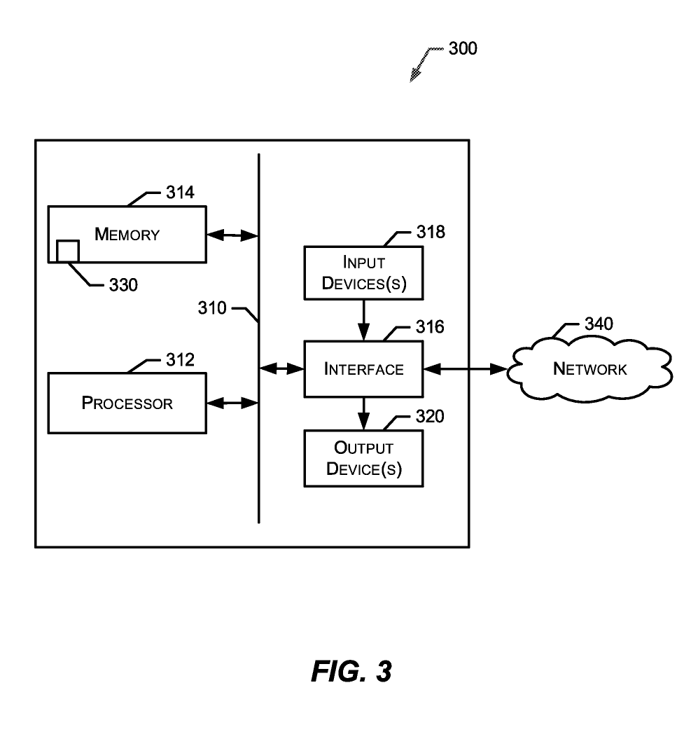

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. PROVIDING RISK METRIC

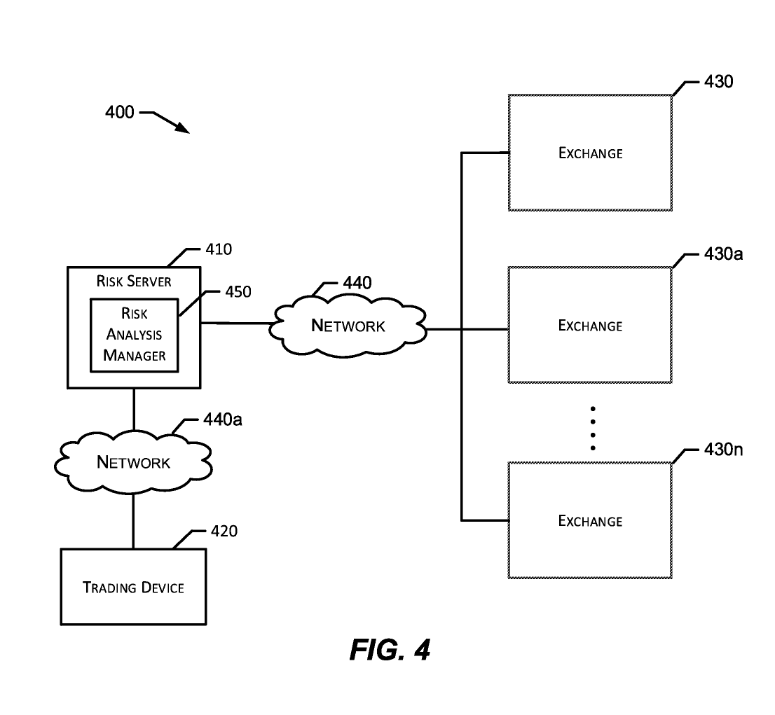

FIG. 4 illustrates a block diagram of an example system 400 that may be used to provide a risk metric related to one or more tradeable objects at an electronic exchange. The system 400 may include a risk server 410 that may receive market data from one or more exchanges, such as exchange 430 and/or exchanges 430a to 430n. The risk server 410 may be a gateway such as the gateway 220 shown in FIG. 2 and/or an edge server. Market data may include data about a market for a tradeable object. For example, market data may include the inside market (e.g., best bid and best ask), market depth, last traded price (“LTP”), a last traded quantity (“LTQ”), or a combination thereof.

The risk server 410 may communicate with the exchanges directly or through a network 440. The following discussion generally focuses on the exchange 430. However, the risk server 410 may also be connected to and communicate with “n” additional exchanges (individually identified as exchanges 430a-430n, which may be similar to exchange 430) by way of the network 440 (or other similar networks) or by way of direct communication.

In certain embodiments, the risk server 410 receives real-time market data about a market for a tradeable object from the exchange 430 for a fee (e.g., a subscription fee). The market data may include the inside market for the tradeable object, the market depth for the tradeable object, the last traded price for the tradeable object, the last traded quantity for the tradeable object, or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The risk server 410 may include a risk analysis manager 450 that may receive the market data for a tradeable object offered at the exchange 430. The risk analysis manager 450 may, in turn, calculate a risk metric for the tradeable object at the exchange 430. The risk metric is a calculated market metric that may be utilized to determine a trader's risk position without subscribing to real-time market data. For example, the risk metric may be a relative value derived from actual price and/or quantity information in the market data. An example risk metric may indicate a price level and/or a range of price levels representing the trading activity for the tradeable object at the exchange 430. The risk metric may be calculated based on, for example, the inside market for the tradeable object, the market depth for the tradeable object, the last traded price for the tradeable object, the last traded quantity for the tradeable object, or a combination thereof.

In certain embodiments, the risk analysis manager 450 determines the best bid price and/or the best offer price, or a range of best bid prices and best offer prices, from the inside market for the tradeable object. The risk analysis manager 450 may determine the best bid quantity and/or the best offer quantity, or a range of best bid quantities and best offer quantities, from the market depth for the tradeable object. The risk analysis manager 450 may calculate the risk metric based on the best bid price, the best bid quantity, the best offer price, the best offer quantity, the last traded price, the last traded quantity, or a combination thereof for a tradeable object at a particular point in time or over a period of time.

In certain embodiments, the risk server 410 may be deployed as part of a trading server and/or a trading terminal (e.g., the server 212 and/or the trading terminal 214). In certain embodiments, the risk server 410 may be deployed as part of a gateway 220 and/or an edge server in communication with the exchange 430 via the network 440. In certain embodiments, the risk analysis manager 450 may be included in one gateway, or may be distributed across one or more gateways and/or edge servers. The risk analysis manager 450 may be executed as software and/or hardware. For example, the risk analysis manager 450 may be a software module included in a trading application that is executed by a processor from memory at the risk server 410, or an independent hardware module.

The risk server 410 may broadcast, communicate and otherwise send the risk metric to one or more computing devices, such as trading device 420 for example. The trading device 420 may be a mobile trading device or another computing device. The risk server 410 may communicate the risk metric to the trading device 420 via the network 440a, which may be the same or a different network than the network 440. Though a single trading device 420 is shown in the system 400, the risk metric may be communicated to multiple computing devices. The risk metric may be communicated in a broadcast message to the computing devices or directly to each computing device via a message that includes a unique identifier of the computing device to receive the message.

The trading device 420 may receive the risk metric and may display the risk metric to a user. The trading device 420 may use the risk metric to determine a level of risk associated with submitting a trade order on the exchange 430. For example, the trading device 420 may measure a user's relative position (e.g., profit or loss) in the market based on the risk metric to determine whether to exit the position. The trading device 420 may determine that the user's relative position in the market is above or below a threshold according to the current price value that may be indicated by the risk metric. For example, the trading device 420 may be used by a risk analysts or risk administrator to perform risk management by calculating a trader's relative position in the market and/or whether the trader should exit the position.

The trading device 420 may receive the risk metric independent of the actual market data. For example, the trading device 420 may receive the risk metric without having access (e.g., network access or a valid subscription) to the market data at the exchange 430. The trading device 420 may use the risk metric to calculate the level of risk associated with submitting trade orders for the tradeable object at the exchange 430 without having to pay the fee associated with receiving the actual market data from the exchange 430. The trading device 420 may receive the risk metric for a relatively smaller fee and/or as a parameter that is provided in the trading application.

In certain embodiments, the risk metric may be updated or otherwise received by the trading device 420 in real time or near real time as a part of a market data update. In certain embodiments, the risk metric may be updated or otherwise received by the trading device 420 according to a delivery schedule (e.g., an update may be received every 15 seconds, an updated may be received at any time between 30 seconds and two (2) minutes. In certain embodiments, the risk metric may be updated or otherwise received by the trading device 420 when it is determined that a difference between the last risk metric and the current risk metric exceeds a predefined threshold (e.g., the risk metric change by more than 15% between updates). In certain embodiments, the risk metric may be updated or otherwise received by the trading device 420 when the last traded price (LTP) occurs away from the inside market.

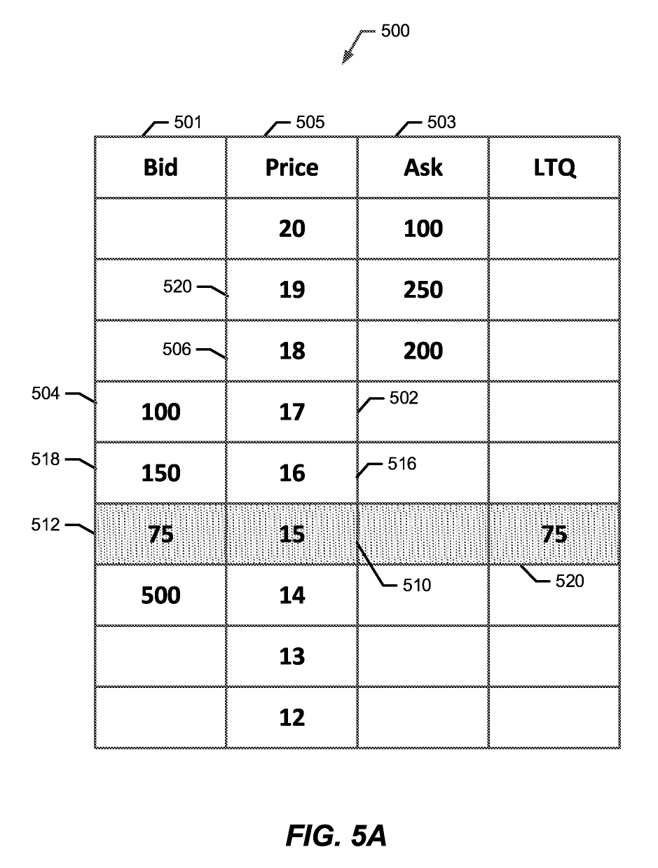

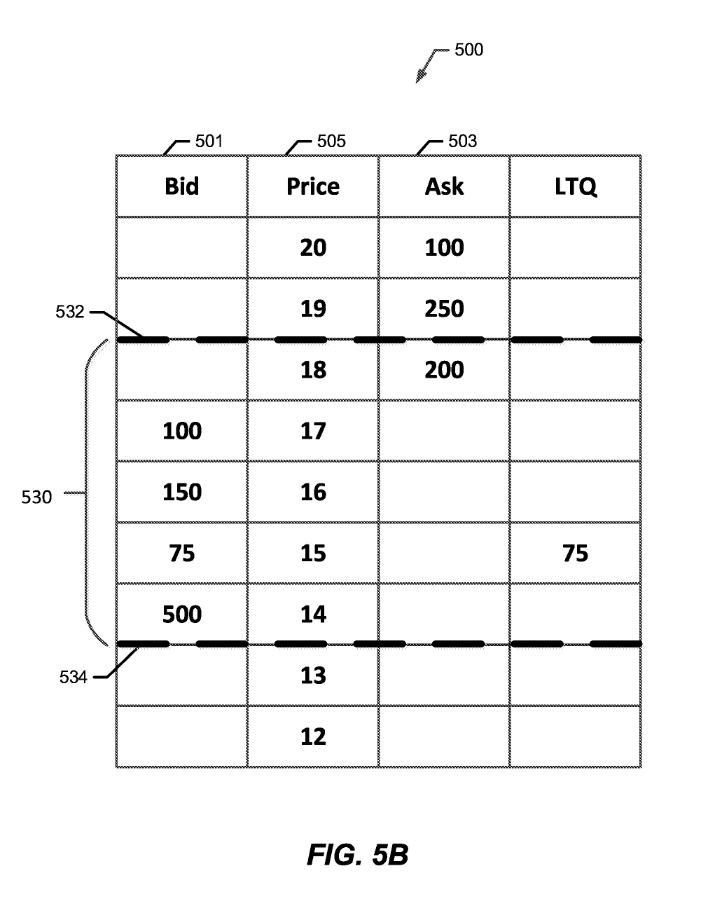

FIGS. 5A-5B illustrate an example display 500 that identifies market data that may be used to generate a risk metric. The example display 500 includes a bid column 501, an ask column 503 and a price column 505. The price or value column 505 provides a plurality of price levels indicating prices and/or other relative value indicators relating to the trading activity of the tradeable object being traded in the market. The bid column 501 includes a plurality of bid quantities arranged according to the plurality of price levels depicted in the price or value column 505. Similarly, the ask column 503 includes a plurality of ask or offer quantities arranged according to the plurality of price levels depicted in the price and/or value column 505. The market data depicted the display 500 may be presented at a computing device, such as a trading device for example. The market data may be received as a cumulative batch of data for display in a trading window or data calculated over a period of time at the computing device.

As illustrated in FIG. 5A, the market data may include a best bid price 502, a best bid quantity 504, a best offer price 506, and/or a best offer quantity 508. The risk metric may be calculated as an average of the best bid price 502 and the best offer price 506. Applying this equation to the values in FIG. 5A, the risk metric would be (17+18)/2, which equals 17.5

The risk metric may be a weighted average that is calculated based on the best bid quantity 504 and the best offer quantity 508. Equation 1 below provides an example for calculating the risk metric as a weighted average of the best bid price 502 and the best offer price 506.

(BBP*BBQ+BOP*BOQ)/(BBQ+BOQ) Equation 1

As illustrated in Equation 1, the risk metric may be calculated by adding a best bid value to a best offer value, and dividing the result by the sum of the best bid quantity 504 and the best offer quantity 508. The best bid value may be the product of the best bid price 502 and the best bid quantity 504. The best offer value may be the product of the best offer price 506 and the best offer quantity 508. Applying this equation to the values in FIG. 5A, the risk metric would be (17*100+18*200)/(100+200), which equals 17.67.

The market data may include a last traded price 510 and/or a last traded quantity 520 which may be used to calculate the risk metric. In certain embodiments, the market data in the display 500 may be received at the time that the bid quantity 512 is matched with the offer quantity 514 to identify the last traded quantity 520. The risk metric may be calculated as an average value of the best bid price 502, the best offer price 506, and the last traded price 510. The risk metric may be a weighted average that is calculated based on the best bid value, the best offer value, and the last traded value. Equation 2 below provides an example for calculating the risk metric as a weighted average of the best bid value, the best offer value, and the last traded value.

(BBP*BBQ+BOP*BOQ+LTP*LTQ)/(BBQ+BOQ+LTQ) Equation 2

As illustrated in Equation 2, the risk metric may be calculated by adding a best bid value to a best offer value and to a last traded value, and dividing the result by the sum of the best bid quantity 504, the best offer quantity 508, and the last traded quantity 520. The best bid value is the product of the best bid price 502 and the best bid quantity 504. The best offer value is the product of the best offer price 506 and the best offer quantity 508. The last traded value is the product of the last traded price 510 and the last traded quantity 520. Applying this equation to the values in FIG. 5A, the risk metric would be (17*100+18*200+15*75)/(100+200+75), which equals 17.13.

The risk metric may be calculated based on a range of best offer prices and/or a range of best bid prices. The risk metric may be calculated as an average value of the best bid prices 502 and 516 and the best offer prices 506 and 520, for example. The risk metric may be calculated with or without the last traded price 510. The risk metric may be calculated using a pre-defined range of last traded prices. The risk metric may be a weighted average that is calculated similar to Equation 1 or Equation 2, using the range of best bid prices 502, 516 and the corresponding best bid quantities 504, 518, the range of best offer prices 506, 520 and the corresponding best offer quantities 508, 522, and/or one or more of the last traded prices and the corresponding last traded quantities. The Equation 3 below provides an example for calculating the risk metric as a weighted average of the range of best bid prices 502 and 516, as well as the range of best offer prices 506 and 520.

(BBP1*BBQ1+BBP2*BBQ2+BOP1*BOQ1+BOP2*BOQ2)/(BBQ1+BBQ2+BOQ1+BOQ2) Equation 3

Equation 4 below provides an example for calculating the risk metric as a weighted average of the range of best bid prices 502 and 516, the range of best offer prices 506 and 520, and the last traded price 510.

(BBP1*BBQ1+BBP2*BBQ2+BOP1*BOQ1+BOP2*BOQ2+LTP*LTQ)/(BBQ1+BBQ2+BOQ1+BOQ2+LTQ) Equation 4

Though Equations 3 and 4 show a range of best bid prices and best offer prices that is equal to two, any number of best bid prices and best offer prices may be included in the range.

As illustrated in Equations 1 to 4, the risk metric may be calculated with or without the last traded price 510. The last traded price 510 may be used to calculate the risk metric when the last traded price 510 comes within a predefined price threshold of the best bid price 502 and/or the best offer price 506. When a range of best bid prices and/or best offer prices are used to calculate the risk metric, the last traded price 510 may be used to calculate the risk metric when the last traded price 510 comes within a predefined price threshold of a best bid price in the range of the best bid prices, comes within a predefined price threshold of a best offer price in the range of the best offer prices, is within the range of best bid prices, or is within the range of best offer prices.

The last traded price 510 may be prevented from being used to calculate the risk metric when the last traded price 510 is outside of the predefined price threshold. The last traded price 510 may be prevented from being used to calculate the risk metric when the trade on which the last traded price 510 did not occur within a predefined period of time (e.g., in minutes or seconds) from the calculation of the risk metric.

The risk metric may be calculated based on a threshold quantity value. In certain embodiments, the threshold quantity value represents a minimum quantity value for which the risk metric may be calculated. The threshold quantity value may be a threshold bid quantity value and/or a threshold offer quantity value. The threshold offer quantity may be determined by counting units from the best offer quantity 508 corresponding to the best offer price 506 and may continue to count units for the best sequential offer prices until the threshold quantity value is reached. As shown in FIG. 5A, if the threshold quantity value is 200, the best offer quantity 508 may meet the threshold quantity value and additional offer quantity values and additional offer price values may not be used to calculate the risk metric. The threshold bid quantity may be met by counting units from the best bid quantity 504 corresponding to the best bid price 502 and may continue to count units for the best sequential bid prices until the threshold quantity value is reached. As shown in FIG. 5A, if the threshold quantity value is 200, the best bid quantity 504 does not meet the threshold quantity value. To meet the threshold quantity value of 200, the risk metric may be calculated cumulatively utilizing 100 units of the bid quantity 504 at the bid price 502 and 100 units of the bid quantity 518 at the bid price 516.

The risk metric may be calculated based on a weighted average using the threshold bid quantity value and the threshold offer quantity value. Using the values in FIG. 5A as an example, the risk metric may be calculated using the range of best bid prices 502 and 516 and the best offer price 506. Equation 5 below provides an example for calculating the risk metric as a weighted average of the range of best bid prices 502 and 516, as well as the best offer price 506.

(BBP1*BBQ1+BBP2*BBQ2+BOP1*BOQ1)/(BBQ1+BBQ2+BOQ1) Equation 5

Applying this equation to the values in FIG. 5A, the risk metric would be (17*100+16*100+18*200)/(100+100+200), which equals 17.25. Though Equation 5 shows a range of two best bid prices and a single best offer price being used to calculate the risk metric, any number of best bid prices and best offer prices may be used to meet the threshold bid quantity value and the threshold offer quantity value.

In certain embodiments, the risk analysis manager may determine the threshold quantity value based on a user input from a computing device. For example, the risk analysis manager may receive messages from computing devices that indicate the threshold quantity values and may determine different risk metrics for computing devices based on the different threshold quantity values.

The threshold quantity value may indicate a quantity that a user may have matched to exit a trading strategy at an exchange. The threshold quantity value may be equal to a complete fill for a trading strategy to exit an exchange. The threshold quantity may be the net position (including the new order) that represents, for example, a specific contract, a specific user, a group of users and/or a whole trading firm. In an example, the threshold quantity value may be equal to a quantity of units that a user may be long or short in the market. For example, a user may have a buy order or a sell order pending at an exchange for 200 units. The threshold quantity value may be equal to the 200 units. The threshold quantity value may be received from a computing device in a message indicating whether the user is long 200 units (e.g., submitted a buy order for 200 units) or short 200 units (e.g., submitted a sell order for 200 units).

The risk metric may be calculated based on a relative price per unit a user may pay to fill a contra-side order having the same quantity as a currently pending order at an exchange. For example, if a user is long 200 units because they bought 200 at an exchange, the risk metric may be calculated based on the best prices of the pending buy orders that may be used to match a sell order submitted by the user having the 200 units to bring the user back to even and exit the position. Using the market data shown in FIG. 5A, if a user is long 200 units and the bid quantities represent quantities of the buy orders at the exchange, the risk metric may be calculated based on a weighted average of the range of best bid prices 502, 516, using the 100 units in the best bid quantity 504 and 100 units of the best bid quantity 518 to meet the threshold quantity value. If a user is short 200 units because they have a sell order pending at an exchange, the risk metric may be equal to the best offer price 506, as the best offer quantity 508 meets the threshold quantity value.

In certain embodiments, the risk metric may be calculated based on the best offer price or best bid price that corresponds to a single respective offer quantity or bid quantity that meets the entire threshold quantity value (e.g., to avoid multiple transaction fees). In certain embodiments, the risk metric may be calculated as a bid risk metric and an offer risk metric. For example, the bid risk metric may be a weighted average of the three bids closest to the inside market (e.g., the highest three bid prices). Similarly, the offer risk metric may be a weighted average of the three offers closest to the inside market (e.g., the lowest three offer prices). In certain embodiments, the bid and offer risk metrics may be calculated utilizing the last traded price as part of the weighted average calculations. In certain embodiments, the user may specify a gap value to modify the risk value. For example, a user may specific a gap value to modify the bid and offer risk metrics and result in a more conservative risk value. If the calculated risk value is 17.24 and the user has defined a gap of 2, the resulting bid and offer risk metrics may be 15.24 and 19.24, respectively.

The risk metric may be based on a long position or a short position of an individual user or for the market at a given time. A long position risk metric or a short position risk metric may be calculated based on a quantity that a user may submit in a trade order to exit an exchange. The long position risk metric and/or the short position risk metric may be calculated based on a pre-defined quantity for a market at a given time that may be used by multiple users.

The risk metric may be calculated by multiplying the threshold quantity value or adding a constant to the threshold quantity value. The multiple or constant may be used to increase the likelihood that a trade order will be filled at a price value indicated by the risk metric. For example, when a threshold quantity value is indicated as being 200 units, the threshold quantity value may be multiplied by three prior to calculating the risk metric. The calculated risk metric may be based on a quantity of 600 units to increase the likelihood that a trade order of 200 units will be filled for at least the value indicated in the risk metric in the event of market changes prior to the trade order being submitted. The threshold quantity value being multiplied or added to may decrease the risk of a user not being able to match a trade order at a given quantity. The risk metric that is based on the multiplied or added to threshold quantity value may be lower than an actual quantity value at which the trade order may be matched.

The risk metric may be calculated by multiplying the threshold quantity value or adding a constant to the threshold quantity value for gappy markets, which may also be referred to as sparse markets. Sparse or gappy markets may have a level of illiquid behavior such that last traded prices and/or last traded quantities may be less reliable for determining an average quantity of the market. For example, sparse or gappy markets may be markets in which the period of time between each trade in a series of trades is greater than a pre-defined threshold. Sparse or gappy markets may also include a series of last traded prices that are relatively unpredictable, as they are outside of an average range of bid price values and/or offer price values.

The risk metric may be calculated with or without the last traded price 510 or the last traded quantity 520 for sparse or gappy markets. The risk metric may be calculated based on a pre-defined range of price values for an inside market and may be calculated without the last traded price 510 or the last traded quantity 520 when the last traded price 510 comes outside of the pre-defined range of price values for the inside market.

The risk metric may be updated and communicated to one or more trading devices in response to an update request and/or upon the occurrence of a market event. The market event may be to an expiration of a timer, the receipt of updated market data, a change in the value of the risk metric, a change in the value of the last traded price 510, a change in the value of the best bid price 502, a change in the value of the best offer price 506, or a combination thereof. The changes in values may cause an update to the risk metric when the values come within or outside of a range of values, meet a certain value within a range of values, or when the values are above or below a threshold.

FIG. 5B illustrates another configuration of the example display 500 that may be used to generate the risk metric. The example display 500 shown in FIG. 5B depicts a predefined risk range 530 that may be identified by an upper limit 532 and a lower limit 534. In the illustrated embodiment of FIG. 5B the upper limit 532 and the lower limit 534 are illustrated with dashed lines. In other embodiments, the risk range 530 may be identified by different indicators such as icons, colored lines, background colors, text style and/or colors. In certain embodiments, the risk metric may be calculated when the last traded price, the best bid price, and/or the best offer price occur beyond the upper risk limit 532 and/or the lower risk limit identifying the risk range 530.

In one embodiment, the risk metric is updated when, for example, one or more of the last traded price, the best bid price, and/or the best offer price are detected beyond the upper limit range 532 or the lower limit range 534 identifying the risk range 530. For example, the risk metric may be calculated when the last traded price occurs beyond the price range indicated by the upper limit range 532 or the lower limit range 534. In other embodiments, the risk metric may be calculated based on the last traded quantity, the best bid price, the best offer price, and/or a derivative thereof. The calculated risk metric can, in turn, be communicated and/or broadcast to one or more trading devices such as the trading device 420.

In certain embodiments, the risk metric may be calculated based on a timing and/or time interval. For example, the risk metric may be calculated and broadcast every 60 seconds, two (2) minutes, five (5) minutes or any other defined schedule. For example, the risk metric may be calculated and broadcast randomly within a predefined time window. The risk metric may be calculated according to a randomly generated trigger occurring within successive time periods of equal lengths. In other embodiments, the risk metric may be calculated when a predefined cumulative quantity has been traded. For example, the risk metric may be calculated and broadcast when a predefined quantity of the tradeable object has been traded.

In certain embodiments, the risk metric may be calculated based on the real-time market data and the delayed market data may be sent, from a risk server or from the exchange, to a trading device that does not pay the fee for the real-time market data. Delayed market data may be received from an exchange or a risk server at a lower fee than the real-time market data or without any fee. In this way, the user may receive a risk metric based on real-time data and may receive the market data on which the risk metric is calculated by paying a lower fee or without paying a fee for the market data.

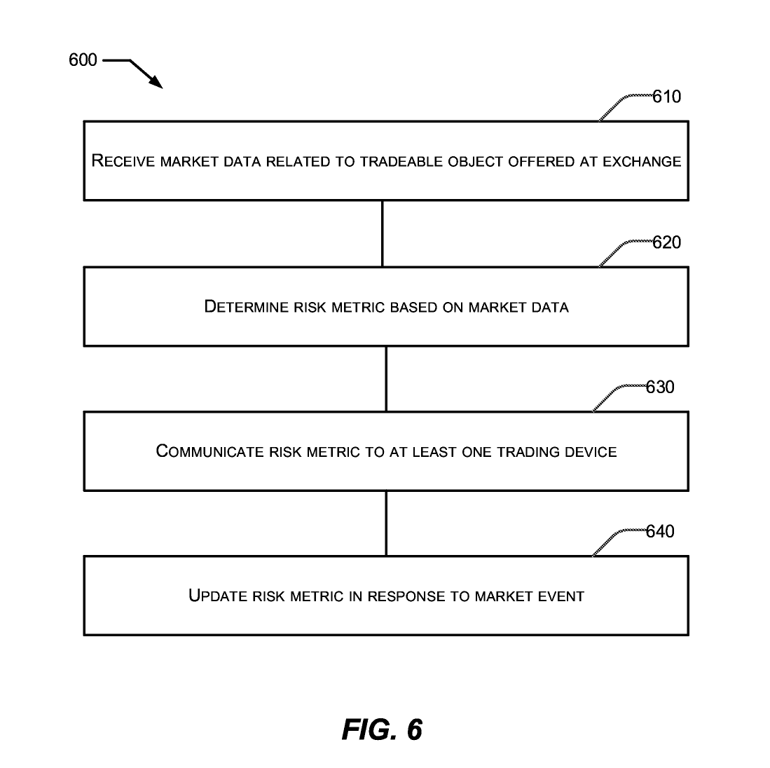

FIG. 6 is a flow diagram of an example method 600 for determining a risk metric based on market data. The method 600, or portions thereof, may be performed by one or more computing devices such as a risk server, a trading device, or another computing device. In an example, the method 600, or portions thereof, may be performed by a risk analysis manager residing at one or more computing devices.

At 610, market data related to a tradeable object offered at an exchange may be received. The market data may be real-time market data received from the exchange for a fee. The market data may include the inside market (e.g., best bid price or prices and the best offer price or prices) for the tradeable object, the market depth (e.g., available quantities at each price) for the tradeable object, the last traded price for the tradeable object, the last traded quantity for the tradeable object, or a combination thereof. A risk metric may be determined, at 620, based on the market data.

Examples are provided herein for how to calculate the risk metric. In one example, the risk metric may be determined based on a best bid value, a best offer value, and/or a last traded value calculated from the market data. The best bid value may be calculated by multiplying the best bid quantity by the best bid price. The best offer value may be calculated by multiplying the best offer quantity by the best offer price. The last traded value may be calculated by multiplying the last traded quantity by the last traded price. A combination or sub-combination of the best bid value, the best offer value, and/or the last traded value may be added together and divided by a sum of the quantity values corresponding to the values in the combination or the sub-combination to generate a relative weighted price value for the risk metric. The risk metric may be calculated using a single price value or a range of price values as described herein.

The risk metric may be communicated to at least one trading device. The risk metric may be communicated to a trading device directly in a message using a unique identifier of the computing device intended to receive the message. The risk metric may be broadcast to multiple trading devices via a broadcast message. The messages may be communicated to trading devices that may pay a fee (e.g., a lower fee than to receive the actual market data) or as a service provided in a trading application running on the trading devices. The user of the trading devices may not pay a separate fee to receive the market data directly from the exchange.

The risk metric may be communicated to the trading devices for being displayed to the user. The user may use the risk metric to calculate a level of risk associated with submitting a trade order at the exchange. For example, the risk metric may indicate a market price value against which a user's relative position (e.g., profit or loss) in the market may be measured to determine whether to exit an exchange. The risk metric may be used to monitor users trading on the exchange without paying a subscription fee to receive the actual market data from the exchange.

The risk metric may be updated, at 640, in response to a user request, a timer, and/or a market event. The market event may be the expiration of a timer or time period, the receipt of updated market data, a change in the value of the risk metric, a change in the value of the last traded price, a change in the value of the best bid price, a change in the value of the best offer price, or a combination thereof. The changes in values may cause an update to the risk metric when the values come within or outside of a range of values, meet a certain value within a range of values, or when the values are above or below a threshold.

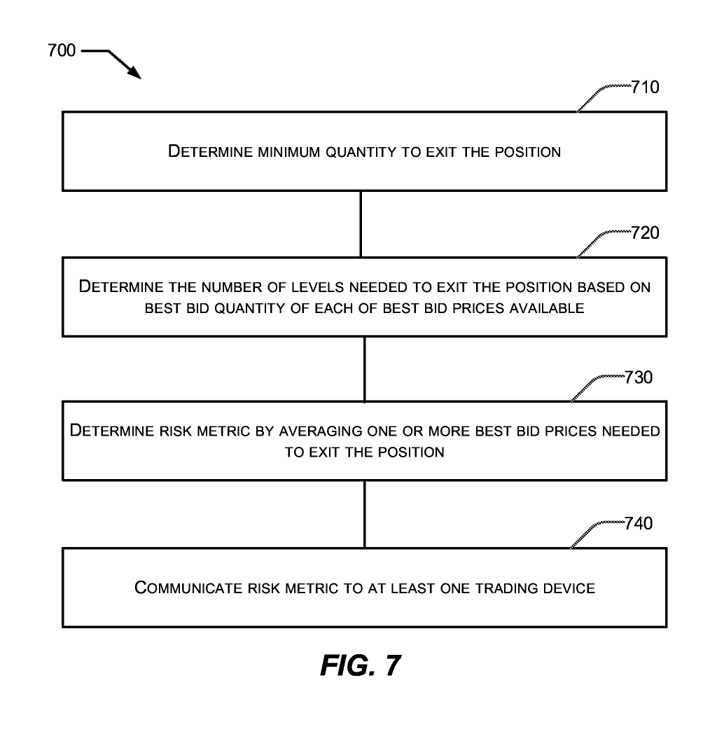

FIG. 7 is a flow diagram of an example method 700 for determining a risk metric according to a minimum quantity value. The method 700, or portions thereof, may be performed by one or more computing devices, such as a risk server, trading device, or another computing device. In an example, the method 700, or portions thereof, may be performed by a risk analysis manager residing at one or more risk servers.

At 710, a minimum quantity to exit the position may be determined. The minimum quantity may be a threshold quantity value. The threshold quantity value may be specified by a user, a trading strategy, an algorithm, or a trading device. For example, the threshold quantity value may be received from a trading device. At 720, one or more best bid prices may be determined that have a corresponding quantity value that meets the threshold quantity value. At 730, the risk metric may be determined by averaging the best bid prices when the quantity for more than one best bid price is used to meet the threshold quantity value. Where multiple best bid prices are used, the risk metric may be determined at 730 using a weighted average of the best bid prices according to the available quantity value for each best bid price. Where a single best bid price has a corresponding quantity value available that meets the threshold quantity value, the risk metric may be set equal to the best bid price and an averaging may not be performed. At 740, the risk metric may be communicated to one or more trading devices.

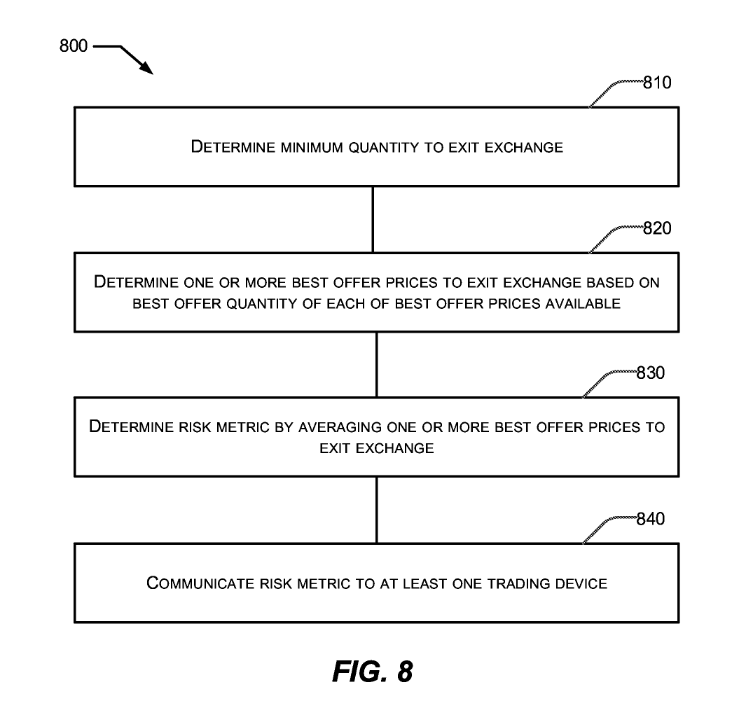

FIG. 8 is a flow diagram of another example method 800 for determining a risk metric according to a minimum quantity value. The method 800, or portions thereof, may be performed by one or more computing devices, such as a risk server, a trading device, or another computing device. In an example, the method 800, or portions thereof, may be performed by a risk analysis manager residing at one or more risk servers.

At 810, a minimum quantity to exit the position may be determined. The minimum quantity may be a threshold quantity value. The threshold quantity value may be specific by a user, a trading strategy, an algorithm, or a trading device. For example, the threshold quantity value may be received from a trading device. At 820, one or more best offer prices may be determined that have a corresponding quantity value that meets the threshold quantity value. At 830, the risk metric may be determined by averaging the best offer prices when the quantity for more than one best offer price is used to meet the threshold quantity value. Where multiple best offer prices are used, the risk metric may be determined at 830 using a weighted average of the best offer prices according to the available quantity value for each best offer price. Where a single best offer price has a corresponding quantity value available that meets the threshold quantity value, the risk metric may be set equal to the best offer price and an averaging may not be performed. At 840, the risk metric may be communicated to one or more computing devices.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
receiving, by a risk analysis manager, market data related to a tradeable object offered at an exchange, wherein the market data comprises at least one of a best bid price, a best bid quantity, a best offer price, or a best offer quantity;
determining, by the risk analysis manager, a risk metric that indicates an average value based on the received market data;
communicating, by the risk analysis manager, the determined risk metric to at least one computing device; and
updating the determined risk metric in response to a market event.

2. The method of claim 1, wherein the average value is a weighted average based on the best bid price, the best bid quantity, the best offer price, and the best offer quantity.

3. The method of claim 2, wherein the market data further comprises a last traded price and a last traded quantity, and wherein the weighted average is based on the last traded price and the last traded quantity.

4. The method of claim 1, wherein the market data comprises a range of best bid prices and a range of best bid quantities, and wherein the risk metric is determined based on the range of best bid prices and the range of best bid quantities.

5. The method of claim 1, wherein the market data comprises a range of best offer prices and a range of best offer quantities, and wherein the risk metric is determined based on the range of best offer prices and the range of best offer quantities.

6. The method of claim 1, wherein the risk analysis manager is executed, from memory, by a processor located at a trading device.

7. A method comprising:
receiving, by a risk analysis manager, market data related to a tradeable object offered at an exchange;
determining, by the risk analysis manager, a risk metric based on the received market data;
communicating, by the risk analysis manager, the determined risk metric to at least one computing device; and
updating the determined risk metric in response to a market event.

8. The method of claim 7, wherein the market data comprises a cumulative batch of data for display in a display window or data calculated over a period of time.

9. The method of claim 7, wherein the market data comprises a best bid price, a best bid quantity, a best offer price, and a best offer quantity.

10. The method of claim 9, wherein the risk metric is determined by calculating a weighted average of the best bid price and the best offer price using the best bid quantity and the best offer quantity.

11. The method of claim 9, wherein the received market data comprises a last traded price and a last traded quantity.

12. The method of claim 11, wherein the risk metric is determined by calculating a weighted average of the best bid price, the best offer price, and the last traded price using the best bid quantity, the best offer quantity, and the last traded quantity.

13. The method of claim 12, wherein the weighted average is calculated without the last traded price or the last traded quantity when a last trade occurred before a predetermined period of time.

14. The method of claim 12, wherein the weighted average is calculated by:
calculating a best bid value by multiplying the best bid quantity and the best bid price;
calculating a best offer value by multiplying the best offer quantity and the best offer price;
calculating a last traded value by multiplying the last traded quantity and the last traded price; and
dividing a sum of the best bid value, the best offer value, and the last traded value by a sum of the best bid quantity, the best offer quantity, and the last traded quantity.

15. The method of claim 7, wherein the communicating comprises broadcasting the risk metric to the at least one computing device.

16. The method of claim 7, wherein the communicating comprises sending the risk metric directly to a computing device via a message that includes a unique identifier of the computing device.

17. The method of claim 7, wherein the risk metric indicates an average value over a plurality of best bid prices or a plurality of best offer prices, and wherein the risk metric indicates the average value to exit a position.

18. The method of claim 17, wherein the market data comprises a plurality of best bid prices and best bid quantities related to the tradeable object at the exchange, the method further comprising:
determining, by the risk analysis manager, a minimum quantity to exit the position; and
determining, by the risk analysis manager, the plurality of best bid prices having corresponding quantities needed to exit the position based on the best bid quantity available at each of the plurality of best bid quantities and the minimum quantity to exit the position, and wherein the risk metric is determined by averaging the plurality of best bid prices.

19. The method of claim 18, wherein the minimum quantity to exit the position is a multiple of a quantity of the tradeable object associated with a user at the exchange.

20. The method of claim 17, wherein the market data comprises a plurality of best offer prices and best offer quantities, the method further comprising:
determining, by the risk analysis manager, a minimum quantity to exit the position; and
determining, by the risk analysis manager, the plurality of best offer prices having corresponding quantities needed to exit the position based on the best offer quantity available at each of the plurality of best offer quantities and the minimum quantity to exit the position, and wherein the risk metric is determined by averaging the plurality of best offer prices.

21. The method of claim 7, wherein the risk metric represents a risk range defined with respect to a calculated risk value.

22. The method of claim 21, wherein the risk metric is updated when the calculated risk value is determined to be within an upper limit range or a lower limit range of the risk range.

23. The method of claim 22, further comprising determining a random value within the upper limit range or the lower limit range, and wherein the risk metric is updated based on the random value within the upper limit range or the lower limit range.

24. The method of claim 7, wherein the market event corresponds to an expiration of a timer, a movement of the risk metric beyond a risk range, or a movement of the risk metric above or below a threshold.

25. The method of claim 7, wherein the risk metric is communicated without the market data.

26. The method of claim 7, wherein the risk analysis manager is executed, from memory, by a processor located at a trading device.
